(19) United States
(12) Patent Application Publication
(10) Pub. No.: US 2015/0088839 A1
(43) Pub. Date: Mar. 26, 2015

(54) REPLACING A CHUNK OF DATA WITH A REFERENCE TO A LOCATION

(71) Applicant: Kevin Lloyd Jones, Bristol (GB)

(72) Inventor: Kevin Lloyd Jones, Bristol (GB)

(21) Appl. No.: 14/394,251

(22) PCT Filed: Jun. 8, 2012
(86) PCT No.: PCT/US2012/041581

§ 371 Date: Oct. 13, 2014

(51) Int. Cl. G06F 17/30

(52) U.S. Cl. CPC G06F 17/30159
USPC 707/692

(57) ABSTRACT

Examples disclose a computing device comprising a deduplication module to analyze a signature associated with a chunk of data to identify a corresponding signature in an index of signatures on a hard drive. The corresponding signature indicates the chunk of data corresponds to a stored chunk of data within a removable media. Further, the deduplication module determines whether the chunk of data is redundant based on the identification of the corresponding signature and replaces the chunk of data with a reference to a location of the stored chunk of data. Additionally, the examples also disclose the removable media to store the reference to the chunk of data.

### BACKGROUND

Data dedication refers to techniques for elimination of redundant data, in the deduplication process, duplicate data is deleted leaving only one copy of the data to be stored, deduplication may be able to reduce the required storage capacity because only unique data is stored.

### BRIEF DESCRIPTION OF THE DRAWINGS

In the accompanying drawings, like numerals refer to like components or blocks. The following detailed description references the drawings, wherein:

FIG. 1 is a block diagram of an example computing device including a deduplication module, hard drive, and removable media to analyze a signature associated with a chunk of data to identify a corresponding signature within an index of signatures and replace the chunk of data with a reference to a location of a stored chunk of data;

FIG. 2 is a block diagram of an example computing device including a deduplication module, hard drive, and removable media to analyze a signature associated with a chunk of data, the signature without correspondence to a corresponding signature within an index of signatures:

FIG. 3 is a block diagram of an example deduplication module to receive a data stream with chunks of data and associated signatures to analyze with the index of signatures on a hard drive and store a reference and/or chunk of data within the removable media;

FIG. 4 is an example flowchart performed on a computing device to retrieve an index of signatures from a removable media, determine whether the chunk of data corresponds to a stored chunk of data, and based on art identification of a corresponding signature either populate the index of signatures or replace the chunk of data with a reference; and

FIG. 5 is a block diagram of a computing device to receive a data stream to generate an associated signature to determine whether a chunk of data corresponds to a stored chunk of data.

By utilizing the deduplication process, storage capacity may be reduced as only unique copses of data are stored. One solution is to utilize a hard drive with the deduplication process. In this solution, the deduplication process identifies and stores the unique chunks of data in the hard drive. However, the hard drive may experience a failure and/or corruption and thus all the data may be lost as it is stored once on the hard drive.

In another solution, a redundant hard drive is utilized with the deduplication process. In this solution, the deduplication process identities and stores the unique chunks of data twice, once in the hard drive and another time in the redundant hard drive. However, this solution is inefficient and may increase the time to perform the deduplication process as the unique chunks of data are repetitively hacked-up on the redundant hard drive. Further, this solution may be expensive as hard drives are more costly than other types of storage. Additionally, both of these solutions are not easily scaled to smaller devices, limiting the types of devices that utilize the deduplication process.

To address these issues, example embodiments disclosed herein provide a computing device with a deduplication module to analyze a signature associated with a chunk of data to determine whether the chunk of data is redundant based on an identification of a corresponding signature within an index of signatures on a hard drive. The corresponding signature indicates the chunk of data corresponds to a previously stored chunk of data. Once the corresponding signature is identified, the chunk of data is replaced with a reference and stored in a removable media. Identifying the corresponding signature from the hard drive improves the performance of fie dedupiscation process. For example, using a type of random access memory to quickly access the index allows the deduplication process to quickly recognize whether the chunk of data is unique or already corresponds to another chunk of data (i.e., redundant chunk of data) and avoiding writes of duplicate data. Further, the removable media provides cost-effective approach to the deduplication process and also enables the deduplication process to scale win smaller devices.

In another embodiment, the dedupiioatiosi module is further to determine if the chunk of data is unique when the signature is without identification to the corresponding signature, in this embodiment, the deduplieafion module adds the signature to the index of signatures on the hard drive. Further, the removable media may store the chunk of data associated with the signature. Determining there is no identification to the corresponding signature, the computing device may determine whether the chunk of data associated with tie signature is unique. This improves the deduplication process as the signature may be added to the index of signatures to be cross-referenced for incoming chunks of data. Further determining the chunk of data is unique, the chunk of data may be stored. This further ensures that unique data is stored rather than redundant copies of data.

In a further embodiment the removable media stores the index of signatures from the hard drive to enable another hard drive operating in conjunction with the removable media to reconstruct the index of signatures. Reconstructing the index of signatures, improves the reliability of the deduplication process as the index of signatures may be fully recoverable in different computing device. Additionally, being able to reconstruct the index of signatures avoids the need for the redundant storage device.

Yet, in another embodiment, the removable media is further to store the chunks of data associated with each of the signatures within the index of signatures from the hard drive to enable the other hard drive to retrieve these chunks of data. This further improves the reliability of the dedupiicaison process by storing the chunks of data associated with each of the signatures within the index of signatures on the removable media. For example, if the hard drive was to corrupt and/or fail, the removable media may be removed from the computing device and used with another computing device to retrieve the stored chunks of data.

In summary, example embodiments disclosed herein provides a cost-effective approach to improve the performance of the deduplication process by utilizing the hard drive and the removable media to avoid writes of duplicate data. Additionally, example embodiments disclosed herein improve the reliability of the deduplication process by utilizing the removable media to store the index of signatures and corresponding chunks of data to reconstruct on other devices should the hard drive corrupt and/or fall.

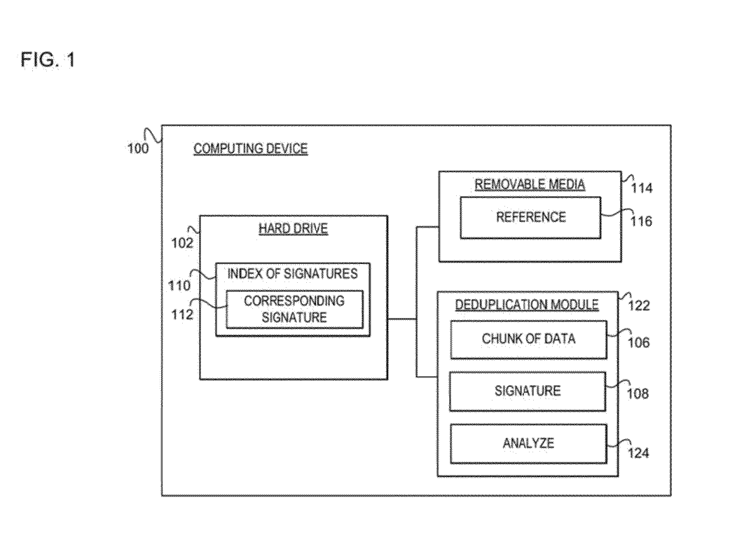

Referring now to the drawings, FIG. 1 is a block diagram of an example computing device 100 including a deduplication module 122, a hard drive 102, and a removable media 114. The deduplication module 122 analyzes a signature 108 associated with a chunk of data 108 at module 124 to identify a corresponding signature 112 within an index of signatures 110 on the hard drive 102. The removable media 114 stores the chunk of data 108 as a reference 118 to a location of a stored chunk of data. Embodiments of the computing device 100 include a client device, personal computer, desktop computer, laptop, a mobile device, or other computing device suitable to include the hard drive 102 and the removable medial 14.

The hard drive 102 includes the index of signatures 110 with the corresponding signature 112. The hard drive 102 is a data storage device for storing and retrieving digital information. In one embodiment, the hard drive 102 is distinguished from the removable media 114 as the hard drive 102 may randomly access the index of signatures 110 to identify the corresponding signature 112. In another embodiment, the hard drive 120 may include fie chunks of data that are associated with each of the signatures including the corresponding signature 112 within the index of signatures 110. Embodiments of the hard drive 102 include a disk drive, non-volatile memory, random access memory, digital memory, magnetic memory, or other type of data storage device capable of storing the index of signatures 110.

The chunk of data 108 is part of a data stream and is associated with the signature 108, in one embodiment, a chunking module (i.e., not pictured) compresses the data stream to generate chunks of data 108 to enable the creation of the signature 108, The chunk of data 108 is reduced to smaller bytes than the data stream which allows the computing device 100 to determine the redundant parts of data. For example, the data stream may be 128 kilobytes and include text such as “There are twelve months in the calendar year,” thus this data stream may be chunked to chunk of data such as “There,” “are,” “twelve,” “months,” etc, in this example, each chunk of data 108 may be only a few kilobytes long, thus reducing the chunks of data 106 into smaller bytes than the data stream. The chunk of data 108 is a value of qualitative or quantitative variables, belonging to a data set (i.e., data stream).

The signature 108 is associated with the chunk of data 108 to identify the chunk of data 108, The signature 108 is distinctive representation of the chunk of data 106 in order to identify the chunk of data 106. In one embodiment, the signature 108 is smaller in file size than the chunk of data 108. This embodiment enables the deduplication module 122 to analyze a smaller file size to determine whether the chunk of data 108 is redundant, In another embodiment, the deduplication module 122 generates the signature 108 associated with the chunk of data 106, while in a further embodiment, the signature 108 is generated from another module, such as a hashing module (i.e., not pictured). Embodiments of the signature 108 include a hash value, hash code, hash sum, check sum, hashes, or other type of signature 108 to identify the chunk of data 106.

The deduplication module 122 includes the signature 108 associated with the chunk of data 108 to analyze at module 124. Embodiments of the deduplication module 122 include an instruction, process, operation, logic, aigonfhm, technique, logical function, firmware and/or software the computing device 100 may fetch, decode, and/or execute to analyze the signature 108 associated with the chunk of data 106 to identify the corresponding signature 112 within the hard drive 102.

The module 124 analyzes the signature 108 to identify the corresponding signature 112. In one embodiment, if the module 124 does not identify the corresponding signature 112, the deduplication module 122 populates the index of signatures no with the signature 108. This embodiment indicates the chunk of data 106 associated with the signature 108 is non-redundant (i.e., unique chunk of data) and thus included in the index of signatures 110, This embodiment is explained in further detail in the next figure. Embodiments of the analyze module 124 an instruction, process, operation, logic, algorithm, technique, logical function, firmware and/or software the computing device 100 may fetch, decode, and/or execute to analyze the signature 108 associated with the chunk, of data 108.

The index of signatures 110 is a data structure which includes the corresponding signature 112 on the bard drive 102, The index of signatures 110 include one or more other signatures that are cross-referenced to determine whether the chunk of data 106 received by the computing device 100 is redundant or unique. The index of signatures 110 may be indexed by these other signatures, as the other signatures indicate chunks of data that is has already been received and stored. In this regard, the stored chunks of data have already been received and processed through the deduplication module 122 to determine if these chunks of data are redundant or unique. In one embodiment, if the chunk of data 106 is deemed unique, then the signature 108 is added to the index of signatures 110 and the associated chunk of data 106 is stored. In another embodiment, if the chunk of data 108 is deemed redundant, then the chunk of data 106 is discarded while the reference 116 to the stored chunk of data is stored within the removable media 114. Embodiments of the index of signatures 110 includes a data table, database, or other type of data structure capable of including the corresponding signature 112 to determine if the chunk of data 106 associated with the signature 108 is redundant or unique.

The corresponding signature 112 is included in the index of signatures 110 on tie hard drive 102 and is associated with the stored chunk of data. In this regard, the deduplication module 122 may cross-reference the index of signatures 110 to determine whether the chunk of data 106 associated with the signature 108 is a redundant chunk of data or unique (i.e., non-redundant). For example, the chunk of data 108 may be received by the computing device 100 and may be redundant of a previous received and stored chunk of data. Thus, the dedpulication module 122 uses the signature 108 as shorthand to identify of the chunk data 108 and eross-referenees this signature 108 to determine if the signature 108 is already within the index of signatures 110. in another embodiment, the corresponding signature 112 is similar io the signature 108 to indicate the chunk of data 106 is redundant, while in a further embodiment, the deduplication module 122 does not identify the corresponding signature 112 (i.e., the signature 108 is without correspondence to the corresponding signature 112) indicating the chunk of data 106 is unique. This embodiment is explained in detail in the next figure. The corresponding signature 112 may be similar in structure to the signature 108 and as such, embodiments of the corresponding signature 112 include a hash value, hash code, hash sum, check sum, hashes, or other type of corresponding signature 112 to identify the stored chunk of data.

The removable media 114 includes a reference 116 to the location of the stored chunk of data associated with the corresponding signature 112. The removable media 114 is a storage media that may be removed from the computing device 100 and placed with other devices, in one embodiment, the removable media 114 stores the chunks of data that are each associated with each signature in the index of signatures 110. In another embodiment, the removable media 114 stores the index of signatures 110 from the hard drive 102. These embodiments enable the removable media 114 to be removed from the computing device 100 and used with other devices. Embodiments of the removable media 114 include a tape storage, memory card, optical disk, floppy disk, zip disk, magnetic tape, or other storage device capable of being removed from the computing device 100.

The reference 118 is metadata that identifies the location of the stored chunk of data associated with the corresponding signature 112. in one embodiment, the stored chunk of data may be stored on the hard drive 102, while in another embodiment, the stored chunk of data may be stored on the removable media 114. In another embodiment, the reference 118 is smaller in file size than the signature 108 and the chunk of data 106. In this embodiment, by replacing the chunk of data 106 with the reference 118; the computing device 100 avoids writes of duplication data. Further, this embodiment helps reduce the storage within the removable media 114 by including the reference 118 which is smaller in size than the chunk of data 106 and thereby allowing more data storage. Embodiments of the reference 118 include a value, text, characters, or other representation to reference the location of a stored chunk of data within the hard drive 102 and/or the removable media 114.

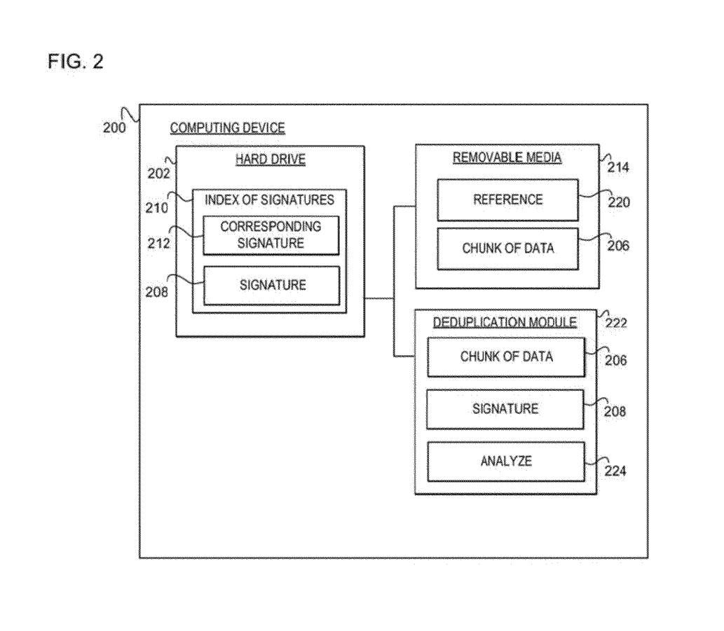

FIG. 2 is a block diagram of an example computing device 200 including a duplication module 222, hard drive 202, and removable media 214 to analyze a signature 208, associated with a chunk of data 208, at module 224. Unlike FIG. 1, FIG. 2 illustrates the deduplication module 222 for detemiining whether the chunk of data 208 is unique. In this embodiment, there is no corresponding signature 212 identified within the index of signatures 210 to correspond with the signature 208. The deduplication module 222 populates the index of signatures 210 with the signature 208 and stores the chunk of data 208 within the removable media 214. Embodiments of the computing device 200, hard drive 202, and the removable media 214 may be similar in structure and functionality to the computing device 100, hard drive 102, and removable media drive 114 as in FIG. 1.

The deduplication module 222 analyzes the signature 208 at module 224 to determine whether the associated chunk of data 208 is unique. Detemiining whether the associated chunk of data 206 is unique, the deduplication module 222 references the index of signatures 210 within the hard drive 202 and based on the signature 208 is without identification and/or correspondence to the corresponding signature 210. The deduplication module 222 and analyze module 224 may similar in structure and functionality to the deduplication module 122 and the analyze module 124 of FIG. 1

The signature 208 is created to identify the chunk of data 208 and analyzed at module 224. The deduplication module 222 utilizes the signature 208 to cross-reference with the index of signatures 210. Once determining the signature 208 is unique and hence the associated chunk of data 206, the deduplication module 222 populates the index of signatures 210 on the hard drive 202 with the signature 208. Further, the deduplication module 222 stores the chunk of data 208 in the removable media 214. The signature 208 may be similar in structure and functionality to the signature 108 as in FIG. 1.

The index of signatures 210 includes the corresponding signature 212 and the signature 208 on the hard drive 202. Although FIG. 2 depicts the index of signatures 210 with the corresponding signature 212 and the signature 208, this was done for illustration purposes and not for limitation purposes. For example, in one embodiment, the index of signatures 210 is without identification to the corresponding signature 212 indicating the chunk of data 206 associated with the signature 208 is unique. In a further example, the index of signatures 210 is without the signature 208 indicates the associated chunk of data 208 is redundant. The index of signatures 210 and the corresponding signature 212 may be similar in structure and functionality to the index of signatures 110 and the corresponding signature 112 as in FIG. 1.

The chunk of data 208 associated with the signature 208 may be stored within the removable media 214 if the chunk of data 206 is considered unique, in another embodiment, the chunk of data 208 may be stored within the hard drive 202 once determined ft is unique. The chunk of data 200 may be similar in structure and functionality to the chunk of data 106 as in FIG. 1.

The reference 220 is included within the removable media 214. Although FIG. 2 depicts the removable media 214 with the reference 220 and the chunk of data 208, this was done for illustration purposes and not for limitation purposes. For example, depending on whether the chunk of data 208 is determined unique or redundant, the removable media 214 may include the reference 220 and/or the chunk of data 208. The reference 220 may be similar in structure and functionality to the reference 120 as in FIG. 1.

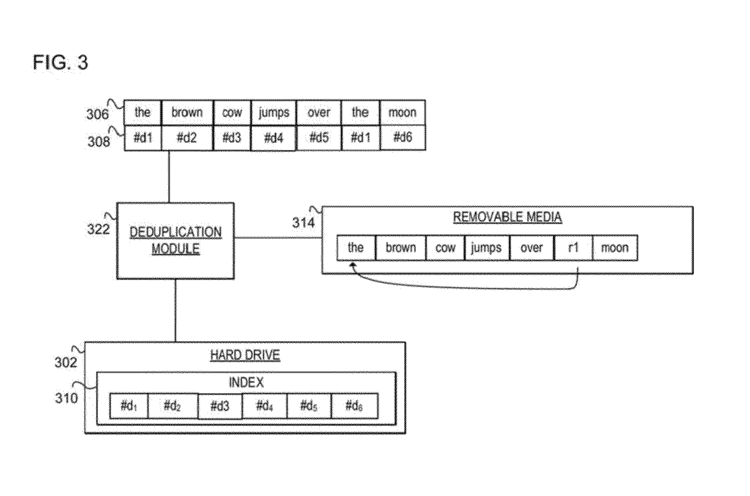

FIG. 3 is a block diagram of an example deduplication module 322 to receive a signatures 308 and associated chunks of data 306 as part of a data stream. Additionally, the deduplication module 322 analyzes the signatures 308 with an index of signatures 310 on a hard drive 302 to determine whether the chunks of data 308 are redundant or unique. Further, the deduplication module 322 stores the chunks of data 308 and/or references in the removable media 314. The deduplication module 322. the hard dnve 302, and the removable media 314 may be similar in structure and functionality to the deduplication module 122 and 222, the hard drive 102. and 202, and the removable media 114 and 214 as in FIGS. 1-2.

The chunks of data 306 are part of a data stream and chunked into smaller file sizes. For example, in this embodiment, the data stream includes, “the brown cow jumps over the moon,” and the chunks of data 306 include, “the,” “brown,” “cow,” “jumps,”0 “over,” “the,” and “moon.” In one embodiment, the chunks of data 308 may be stored on the hard drive 302 as each is associated with the signatures 308 within the index of signatures 310. In a further embodiment, the chunks of date 308 may be stored on the removable media 314. The chunks of data 306 may be similar in structure and functionality to the chunk of data 106 and 208 as in FIGS. 1-2.

The signatures 308 are each representations used to identify each of the chunks of data 308. For example, the signature “#d1” identifies the chunk of data “the”; “#d2,” identifies brown”; “#d3,” identifies “cow”; “#d4,” identifies “jumps”; “#d5,” identifies “over”; and “#d6,” identifies “moon,”. The signatures 308 may be similar in structure and functionality to the signature 108 and 206 as in FIGS. 1-2.

The index of signatures 310 includes signatures 308 and is located within the hard drive 302. The index of signatures 310 is used to cross-reference with each of the signatures 308 to determine if the associated chunk of data 306 is redundant or unique. In FIG. 3, the chunk of data 306 “the” is considered redundant and is indicated by signature “#d1” and the corresponding signature “#d1” within the index of signatures 310 on the hard drive 302. For example, the deduplication module 322 may receive the signature “#d1,” identifying the associated chunk of data 308, “the.” In this example, the dedpulication module 322 analyzes, “#d1” to determine if there is a corresponding signature within the index of signatures 310. In this case, “#d1,” appears already in the index of signatures as the corresponding signature, so the signature received at the deduplication module 322 may be discarded while the chunk of data, “the,” is stored with reference “r1” indicating the location of the stored chunk of data, “the.” In another example, the dedpulication module may receive signature “#d7” (i.e., not pictured) which identifies a chunk of data “fox.” in this example, the deduplication module 322 cross-references the index of signatures 310 and determines there is no corresponding signature within the index 310. Thus, the signature WT is added to the index 310 and the associated chunk of data “fox,” may be stored within the removable media 314 and/or hard drive 302. This example illustrates the chunk of data, “fox,” that is considered unique.

The removable media 314 includes the chunks of data 308 with the reference, “r1.” The reference, “r1,” identifies a location of the chunk of data “the.” The location may be within the removable media and/or hard drive 302, in this embodiment, the arrow points to the location of, “the,” as stored in the removable media 314. In another embodiment, the index of signatures 310 is stored to the removable media 314 so the removable media 314 may be used in conjunction with another hard drive. In this embodiment, the other hard drive may reconstruct the index of signatures 310 to be used for future incoming chunks of data, in a further embodiment, the chunks of data 308 associated with the signatures 308 in the index of signatures 310 are stored in the removable media 314 for another hard drive to retrieve. These embodiments enable the removable media 314 to be removed and used in other devices.

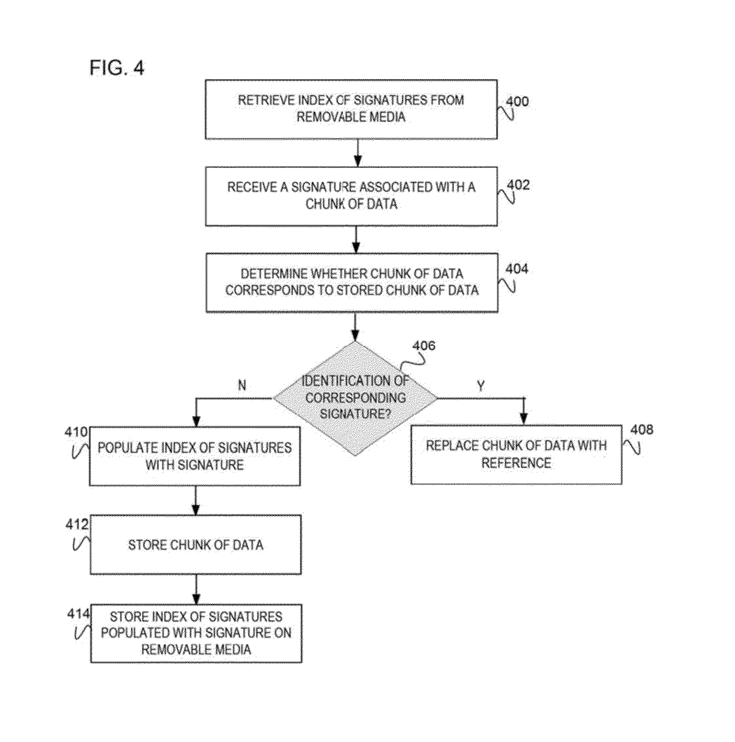

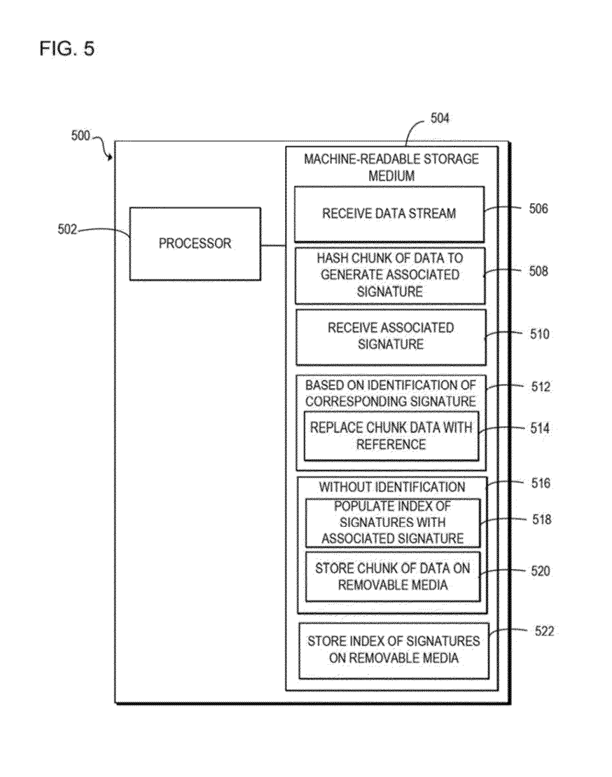

FIG. 4 is an example flowchart performed on a computing device to retrieve an index of signatures from a removable media, determine whether the chunk of data corresponds to a stored chunk of data based on the correspondence of a signature to a corresponding signature within an index of signatures within a hard drive. Further, based on the identification or non-identification of the corresponding signature, the flowchart populates an index of signatures with the signature and stores the associated chunk of data or replaces the chunk of data with a reference to a location of the stored chunk of data on the removable media. Although FIG. 4 is described as being performed on computing device 100 and 200 as in FIG. 1 and FIG. 2, it may also be executed on other suitable components as will be apparent to those skilled in the art. For example, FIG. 4 may be implemented in the form of executable instructions stored on a machine-readable storage medium, such as machine-readable storage medium 504 as in FIG. 5 or in the form of electronic circuitry.

At operation 400 the hard drive retrieves an index of signatures from the removable media, in one embodiment, operation 400 occurs after operation 414. In this embodiment, the index of signatures is stored on the removable media from the hard dive, and a second hard drive retrieves the index of signatures. This enables the removable media to operate with other devices and other hard drives, in another embodiment, operation 400 occurs prior to operation 402.

At operation 402 a deduplication module receives a signature associated with a chunk of data. In one embodiment of operation 402, the computing device receives a data stream and chunks the data stream into chunks of data and generates signatures associated with each chunk of data to identify the data chunk. In this embodiment, the deduplication module receives the signature internally from the computing device that chunks the data. In another embodiment, operation 402 receives the signature externally to the computing device. In a further embodiment, operation 402 receives the associated chunk of data along with the signature.

At operation 404 the deduplication module determines whether the chunk of data corresponds to a stored chunk of data by analyzing the signature received at operation 402. In one embodiment operation 404 includes cross-referencing the index of signatures within the hard drive. In another embodiment, operation 404 occurs simultaneously with operation 408 to identify the corresponding signature within the index of signatures on the hard drive. In a further embodiment, operation 404 occurs prior to operation 403.

At operation 406 the deduplication module identifies the corresponding signature. At operation 406, the signature received and analyzed at operations 402 and 404, is cross-referenced against the index of signatures to identify the corresponding signature that may be similar to the signature. In one embodiment, operation 408 includes determining whether the chunk of date associated with the signature is redundant or unique based on the identification of the corresponding signature within the index of signatures on the hard drive. In another embodiment, if operation 408 determines there is no corresponding signature this indicates the chunk of data associated with the signature is unique and the Sow chart proceeds to operations 410-414. In a further embodiment, if the operation 408 identifies the corresponding signature, this indicates the chunk of data associated with the signature is redundant and the flowchart proceeds to operation 408.

At operation 408, the chunk of data associated with the signature received at operation 402, is replaced with a reference. The reference is metadata that identifies a location of the stored chunk of data and this reference is stored in the removable media. In this embodiment, operation 408 includes determining the chunk of data is redundant (i.e., without identification to the corresponding signature), in another embodiment, operation 408 discards the chunk of data, in a further embodiment, operation 408 includes the reference to the location of the stored chunk of data within the hard drive and/or removable media.

At operation 410 the hard drive populates the index of signatures on the hard drive wth the signature received at operation 402, in another embodiment, operation 410 occurs simultaneously with operation 412, while in a further embodiment, operation 410 occurs after operation 408 once determining the chunk of data associated with the signature is unique.

At operation 412 the chunk of data associated with the signature received at operation 402 is stored on the removable media. In another embodiment, operation 412 stores the chunk of data on the tape drive. In this embodiment, the chunk of data is stored on the tape drive prior to storage on the removable media.

At operation 414 the index of signatures with the populated signature at operation 410 is stored on the removable media. In another embodiment, operation 414 includes storing the chunks of data associated with each of the signatures within the index of signatures on the removable media. In a further embodiment, operation 414 includes removing the removable media from the computing device for use to reconstruct the index of signatures and/or retrieve associated chunks of data on another hard drive and/or other computing device.

FIG. 5 is a block diagram of a computing device 600 to receive a data stream Including a data chunk, generate an associated signature to determine whether the chunk of data corresponds to a stored chunk of data. Although the computing device 500 includes processor 502 and machine-readable storage medium 504, it may also include other components that would be suitable to one skilled in the art. For example, the computing device 502 may include hard drive 102 and 202 as in FIGS. 1-2. Additionally, the computing device 500 may include the structure and functionality of the computing devices 101 and 200 as set forth above in FIGS 1-2.

The processor 502 may fetch, decode, and execute instructions 506, 608, 510, 512, 514, 518, 518, 520, and 522. Embodiments of the processor 502 include a microchip, chipset, electronic circuit, microprocessor, semiconductor, controller, microcontroller, central processing unit (CPU), graphics processing unit (GPU), visual processing unit (VPU), or other programmable device capable of executing instructions 508-522. The processor 502 executes instructions to receive a data stream to chunk into a chunk of data instructions 508; hash the chunk of data to generate the associated signature instructions 508; receive the associated signature to determine whether the chunk of data corresponds to a stored chunk of data instructions 510; based on the identification of the corresponding signature instructions 512; replace the chunk of data with a reference to identify a location of the stored chunk of data instructions 514; if the corresponding signature is without identification instructions 518; populate the index of signatures with the signature instructions 518; store the associated chunk of data on the removable media instructions 520; and store the index of signatures on the removable media instructions 522.

The machine-readable storage medium 504 may include instructions 508-522 for the processor 502 to fetch, decode, and execute. The machine-readable storage medium 504 may be an electronic, magnetic, optical, memory, flash-drive, or other physical device that contains or stores executable instructions. Thus, the machine-readable storage medium 504 may include for example, Random Access Memory (RAM), an Electrically Erasable Programmable Read-Only memory (EEPROM), a storage drive, a memory cache, network storage, a Compact Disc Read Only Memory (CD-ROM) and the like. As such, the machine-readable storage medium 504 can include an application and/or firmware which can be utilized independently and/or in conjunction with the processor 502 to fetch, decode, and/or execute instructions on the machine-readable storage medium 504. The application and/or firmware can be stored on the machine-readable storage medium 504 and/or stored on another location of the computing device 500.

In summary, example embodiments disclosed herein provides a cost-eflecive approach to improve the performance of the deduplication process by utilizing the hard drive and the removable media to avoid writes of duplicate data. Additionally, example embodiments disclosed herein improve the reliability of the deduplication process by utilizing the removable media to store the index of signatures and corresponding chunks of data to reconstruct on other devices should the hard drive corrupt and/or fail

We claim:

1. A computing device comprising:
a deduplication module to;
analyze a signature associated with a chunk of data to identify a corresponding signature in an index of signatures on a hard drive, the corresponding signature indicates the chunk of data corresponds to a stored chunk of data; and
determine whether the chunk of data is redundant based on the identification of the corresponding signature, replace the chunk of data with a reference to a location of the stored chunk of data; and
a removable media to store the reference to the chunk of data,

2. The computing device of claim 1 wherein the deduplication module is further to determine whether the chunk of data is unique based on the signature is without identification to the corresponding signature, the deduplication module is further to:
populate the index of signatures on the hard drive with the signature; and
the removable media is further to store the chunk of data associated with the signature.

3. The computing device of claim 1 wherein the index of signatures is retrieved from the removable media to store on the hard drive to analyze the signature.

4. The computing device of claim 1 wherein the removable media is further to store the index of signatures from the hard drive to enable another hard drive operating in conjunction with the removable media to reconstruct the index of signatures.

5. The computing device of claim 4 wherein the removable media is further to store chunks of data associated with the index of signatures from the hard drive to enable the other hard drive to retrieve the stored chunks of data from the removable media.

6. The computing device of claim 1 wherein the reference is smaller in file size than the signature and the signature is smaller in file size than the chunk of data.

7. A method executed on a computing device, the method comprising:
receive a signature associated with a chunk of data;
determining whether the chunk of data corresponds to a stored chunk of data by analyzing the signature to identify a corresponding signature within an index of signatures on a hard drive; and
based on the identification of the corresponding signature, replacing the chunk of data with a reference associated with the corresponding signature to store in the removable media, the reference identifies a location of the stored chunk of data.

8. The method of claim wherein the signature is without identification to the corresponding signature, the method is further comprising:
populating the index of signatures on the hard drive with the signature; and
storing the chunk of data associated with the signature.

9. The method of claim 8 further comprising;
storing the index of signatures populated with the signature from the hard drive to the removable media to enable another hard drive to reconstruct the index of signatures.

10. The method of claim 9 further comprising:
storing chunks of data associated with the index of signatures to the removable media to enable retrieval of the chunks of data associated with the index of signatures by the other hard drive.

11. The method of claim 7 wherein the index of signatures is retrieved, from the removable media and stored on the hard drive to identify the corresponding signature within the index of signatures.

12. The method of claim 7 further comprising:
retrieving the stored chunk of data from the removable media corresponding to the chunk of data;
store the stored chunk of data on the hard drive; and
discard the stored chunk of data from the removable media.

13. A non-transitory machine-readable storage medium encoded with instructions executable by a processor of a computing device, the storage medium comprising instructions to:
generate an associated signature representing a chunk of data, the chunk of data as part of a data stream;
a hard drive to receive the associated signature to determine whether the chunk of data corresponds to a stored chunk of data within a removable media by analyzing the associated signature to identify a corresponding signature within an index of signatures on the hard drive;
based on the identification of the corresponding signature, replace the chunk of data with a reference associated with the corresponding signature, the reference identifies a location of the stored chunk of data; and
wherein if the associated signature is without identification to the corresponding signature, populate the index of signatures on the hard drive with the associated signature and store the chunk of data on the removable media.

14. The non-transitory machine-readable storage medium of claim 13, further comprising instructions to:
store the index of signatures from the hard drive to the removable media to enable the removable media operating in conjunction with another hard dnve to reconstruct the index of signatures.

15. The non-transitory machine-readable storage medium of claim 13, further comprising instructions to:
receive the data stream to chunk the data stream into the chunk of data; and
hash the chunk of data to generate the associated signature.
